(19) United States
(12) Patent Application Publication
(10) Pub. No.: US 2024/0021383 A1
(43) Pub. Date: Jan. 18, 2024

(54) LOCKING PIN MECHANISM FOR KEYBOARD ASSEMBLY OF AN INFORMATION HANDLING SYSTEM

(71) Applicant: Dell Products L.P., Round Rock, TX (US)

(72) Inventors: Deeder Aurongzeb, Austin, TX (US); Weijong Sheu, Austin, TX (US); Chad Rabe, Round Rock, TX (US)

(73) Assignee: Dell Products L.P., Round Rock, TX (US)

(21) Appl. No.: 17/812,013

(22) Filed: Jul. 12, 2022

(51) Int. Cl. B41J 29/56

(52) U.S. Cl. CPC B41J 29/56

(57) ABSTRACT

Disclosed is a keyboard for an information handling system. The keyboard includes a keycap frame having a plurality of keycaps. They keycap frame is coupled to a cover using at least one retractable locking pin. The keycap frame can be positioned between a top cover and a bottom cover, and the top cover can include one or more openings for the plurality of keycaps to protrude through. The keycap frame and the first cover can be coupled without using screws.

### FIELD OF THE DISCLOSURE

This disclosure relates to information handling systems. More specifically, portions of this disclosure relate to a keyboard for an information handling system. In some embodiments, a keycap frame is coupled to a cover using at least one retractable locking pin. In some embodiments, a keycap frame is coupled to a cover without using screws.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The increase in the number of information handling systems used by consumers, and the pace at which new models are introduced creates a situation in which many consumers replace electronic device components on a frequent basis. Many of these components are discarded as waste, end up in landfills, and remain buried in our planet for hundreds of years, if not longer. Because information handling systems and keyboards have many components and are generally assembled using screws, disassembly of the components may be difficult, burdensome, or both. This hinders the ability of consumers and companies to recycle, reuse, or decompose keyboard components made of recyclable or biodegradable materials.

### SUMMARY

Plastics are used in electronic and electrical device parts, such as keyboards, due to their light weight and good mechanical properties. However, commonly used plastics, (e.g., certain polycarbonates, polyesters, acetals, etc.) are not biodegradable, and if not recycled, can create environmental problems (e.g., landfill contamination, increased use of natural resources and energy, etc.). Further, as demands on information handling systems have resulted in size reductions, the keyboard assemblies may include a combination of mechanical attachments such as screws with bonding. The bonding further reduces the biodegradability of the system components. The increase in pace and number of plastics from information handling systems can be offset by better design of device parts, such as keyboards, to facilitate recycling and biodegradability.

One challenge to the biodegradability and recyclability of components of an information handling system is the usage of screws to affix components together. The screws may be made from metal or other non-biodegradable materials. Thus, even though biodegradable or recyclable materials are used in portions of the components, the metal screws affixing the components prevents the information handling system from being environmentally-friendly.

Embodiments of this disclosure may include one or more of bio-degradable material with bio-degradable adhesive and ultrasonic-welded edges. To reduce the number of screws (or other non-bio-degradable mechanical attachment devices) or eliminate the use of screws (or other non-bio-degradable mechanical attachment devices), a recessed pocket and a retractable locking pin may be used to secure components together, such as components of a keyboard assembly for an information handling system. Ultrasound welding with a bio-based epoxy may be used to further secure components of the keyboard assembly. The bio-based epoxy may include up to 25, 35, 40, 45, 50, 55, or 60% bio-based carbon content. One or more of the components may be made from 120 degree Celsius melting point biodegradable plastic.

A sustainably-sourced and environmentally-friendly keyboard that exhibits high strength and durability may reduce some of the waste product left behind by information handling systems after they reach end-of-life. The keyboard may include recycled, recyclable, and/or biodegradable plastics, adhesives, and metallic components that provide a reduced environmental footprint, as compared to traditional keyboards. The keyboard's recycled, recyclable, and/or biodegradable components are assembled and arranged to provide strength and durability that is substantially similar to, equal to, or greater than traditional keyboards. Some components are designed for tool-less assembly and disassembly while still providing strength and durability.

Recyclable and/or biodegradable plastics may be used in components of the information handling system to improve the impact of the waste on the environment. Additionally, in some embodiments, there may be no screws for affixing the components because the components are welded together.

According to one embodiment of the disclosure, an apparatus may include a keycap frame with a rectangular portion having a plurality of keycaps, a first tab coupled to one edge of the rectangular portion, a first retractable locking pin coupled to a first end of the first tab and configured to retract in a first direction, and a second retractable locking pin coupled to a second end of the first tab and configured to retract in a second direction that is opposite to the first direction.

In some embodiments, the apparatus may include a first cover. The first cover may include a first recessed pocket configured to receive the first retractable locking pin and a second recessed pocket configured to receive the second retractable locking pin. In some embodiments, the movement of the keycap frame relative to the first cover may be at least partially restricted when the first recessed pocket has received the first retractable locking pin and the second recessed pocket has received the second retractable locking pin. In some embodiments, the keycap frame may be coupled to the first cover without using screws. In some embodiments, the first cover may include one or more openings. In some embodiments, the plurality of keycaps may be configured to protrude through the one or more opening of the first cover.

In some embodiments, the apparatus may include a second cover. In some embodiments, a portion of the keycap frame may be positioned between a portion of the first cover and a portion of the second cover. In some embodiments, at least a portion of a perimeter of the first cover may be coupled with an ultrasound bioepoxy weld to at least a portion of a perimeter of the second cover.

In some embodiments, the first cover may include at least one of biodegradable material, recyclable material, or bioplastic material. In some embodiments, the keycap frame may include at least one of biodegradable material, recyclable material, or bioplastic material. In some embodiments, the second cover may include at least one of biodegradable material, recyclable material, or bioplastic material. In some embodiments, the first cover may include a polyester and a plurality of jute fibers. In some embodiments, the second cover may include a first polylactic acid (PLA) and a post-consumer resin (PCR). In some embodiments, the keycap frame may include sprayed graphene black matrix.

In some embodiments, the first tab, the first retractable locking pin, and the second retractable locking pin may be part of a fastener. In some embodiments, the apparatus may include one or more of the fastener and a first cover with one or more of a recessed pocket configured to receive at least one of the first retractable locking pin or the second retractable locking pin of at least one of the one or more fastener. In some embodiments, the keycap frame is coupled to the first cover without using screws.

According to one embodiment of the disclosure, an apparatus may include a keyboard assembly including a keycap frame with a rectangular portion having a plurality of keycaps, a first tab coupled to one edge of the rectangular portion, a first retractable locking pin coupled to a first end of the first tab and configured to retract in a first direction, a second retractable locking pin coupled to a second end of the first tab and configured to retract in a second direction that is opposite to the first direction, a first cover with one or more of an opening and including a first recessed pocket configured to receive the first retractable locking pin to at least partially restrict movement of the keycap frame relative to the first cover and a second recessed pocket configured to receive the second retractable locking pin to at least partially restrict movement of the keycap frame relative to the first cover, and a second cover configured to couple to the first cover to create a volume that can at least partially enclose the keycap frame. In some embodiments, a portion of the keycap frame may be positioned between a portion of the first cover and a portion of the second cover. In some embodiments, the plurality of keycaps may be configured to protrude through the one or more opening of the first cover.

In some embodiments, the apparatus may be an information handling system. In some embodiments, the information handling system may include a processor coupled to the keyboard assembly and configured to receive input from the keyboard assembly. In some embodiments, the information handling system may include a display coupled to the processor. In some embodiments, the keycap frame is coupled to the first cover without using screws. In some embodiments, at least a portion of a perimeter of the first cover may be coupled with an ultrasound bioepoxy weld to at least a portion of a perimeter of the second cover. In some embodiments, the first cover may include at least one of biodegradable material, recyclable material, or bioplastic material. In some embodiments, the keycap frame may include at least one of biodegradable material, recyclable material, or bioplastic material. In some embodiments, the second cover may include at least one of biodegradable material, recyclable material, or bioplastic material. In some embodiments, the first cover may include a polyester and a plurality of jute fibers. In some embodiments, the second cover may include a first polylactic acid (PLA) and a post-consumer resin (PCR). In some embodiments, the keycap frame may include sprayed graphene black matrix.

Some embodiments may include retracting a first retractable locking pin and a second retractable locking pin of one or more tabs of a keycap frame. Some embodiments may include aligning the first retractable locking pin and the second retractable locking pin of the one or more tab with at least one of one or more of a recessed pocket of a first cover, in which the one or more recessed pocket is configured to receive at least one of the first retractable locking pin or the second retractable locking pin of at least one of the one or more tab. Some embodiments may include releasing the first retractable locking pin and the second retractable locking pin of the one or more tab to extend the first retractable locking pin in the second direction and to extend the second retractable locking pin in the first direction, in which the extension of the first retractable locking pin and the second retractable locking pin of the one or more tab causes the first retractable locking pin and the second retractable locking pin to be received by at least one of the one or more recessed pocket of the first cover to at least partially restrict movement of the keycap frame relative to the first cover.

Some embodiments may include positioning a portion of the keycap frame between a portion of the first cover and a portion of a second cover, in which the one or more keycap are configured to protrude through one or more openings of the first cover. Some embodiments may include coupling a portion of a perimeter of the first cover and a portion of a perimeter of the second cover using an ultrasound bioepoxy weld. Some embodiments may include coupling a keyboard assembly including the keycap frame, the first cover, and the second cover to a processor configured to receive input from the keyboard assembly. Some embodiments may include coupling a display to the processor.

The following includes definitions of various terms and phrases used throughout this specification.

As used herein, biodegradability of a material refers to the rate at which the material breaks down to its basic components for blending back in with the earth. A material described as biodegradable may have a decomposition rate such that 90% of the material has broken down to basic components within ten years in either a controlled or uncontrolled composting arrangement.

As used herein, recycled content of a material refers to wt. % of the material obtained from, made from, and/or recovered from waste. Unless mentioned otherwise the waste can be post-industrial and post-consumer waste. Post-consumer waste of a material can include waste generated by a customer of a substrate containing the material. Post-industrial waste can include waste generated during a production process of a product and has not been used in the consumer market. Recycled content can be from mechanically and/or chemically recycling processes.

As used herein, renewable content of a material refers to wt. % of the material obtained from or made from a bio-based renewable material. Unless mentioned otherwise, bio-based material can include materials from any life form such as plants, animals, fungi, protists, prokaryotes, microbes, algae, bacteria, yeasts, and/or moulds. The bio-based material can be obtained from natural or genetically engineered species. Non-limiting examples of bio-based renewable material includes tall oil, sugar, castor beans, and/or CO2, such as waste CO2.

As used herein total recycled and renewable content of a material refers to wt. % of the material obtained from, made from and/or recovered from waste and wt. % of the material obtained from or made from a bio-based renewable material. For example, for a 100 gm material is 10 gm is obtained recycled sourced and 10 gm is obtained from renewable source, the total recycled and renewable content of the material is 20 wt. %.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1: Top view schematic of a first example of an apparatus according to some aspects of the present disclosure.

FIG. 2: Top view schematic of the first example of an apparatus according to some aspects of the present disclosure.

FIG. 3: Bottom view schematic of the first example of an apparatus according to some aspects of the present disclosure.

FIG. 4: Top view schematic of a second example of an apparatus according to some aspects of the present disclosure.

FIG. 5: Bottom view schematic of the second example of an apparatus according to some aspects of the present disclosure.

FIG. 6: Schematic of a third example of an apparatus according to some aspects of the present disclosure.

FIG. 7: Schematic of the third example of an apparatus according to some aspects of the present disclosure.

FIG. 8: Schematic of a fourth example of an apparatus according to some aspects of the present disclosure.

FIG. 9: Flow diagram of a method of assembling an apparatus according to an example of the present disclosure.

FIG. 10: Block diagram of an example information handling system.

### DETAILED DESCRIPTION

These example embodiments describe and illustrate various keyboards and keyboard components of an information handling system.

Tool-less assembly and disassembly may help separate components easily and quickly. Recyclable and biodegradable components may be separated from non-recyclable and non-biodegradable components, and the components may be discarded responsibly, such as by recycling or decomposing the components. The reduced difficulty and length in separating recyclable and non-recyclable components also make it more feasible—and probable—for consumers to actively participate in the recycling or decomposing of components of information handling systems, which in turn improves sustainability and reduces environmental impact.

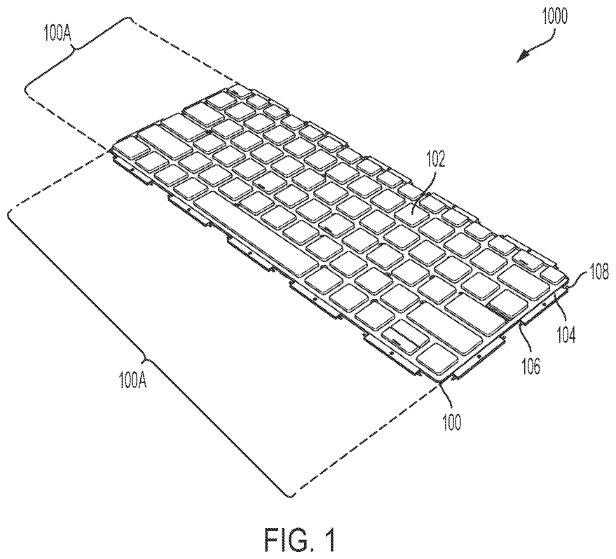

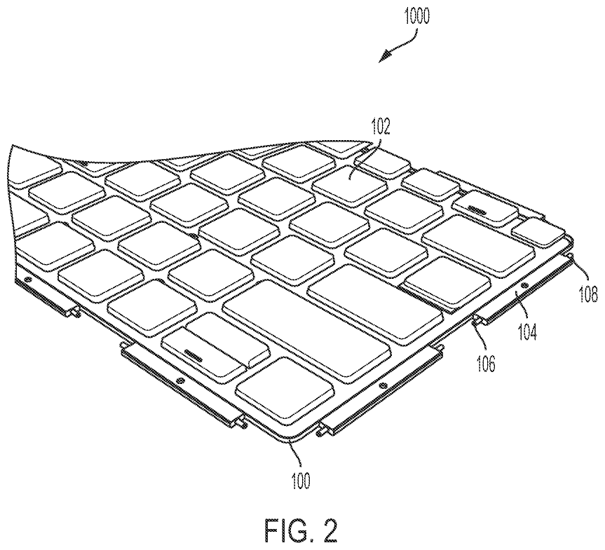

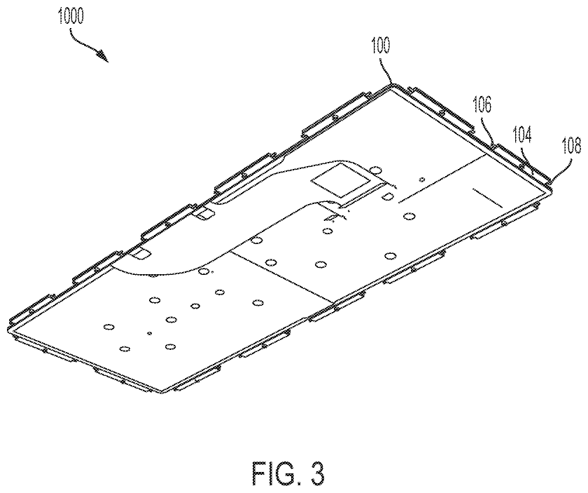

Referring to FIGS. 1, 2, and 3, a schematic of an apparatus according to an example of the present disclosure is shown. The apparatus includes a keycap frame 100, a first tab 104, a first retractable locking pin 106, and a second retractable locking pin 108.

The keycap frame 100 includes a rectangular portion 100A having a plurality of keycaps 102. The rectangular portion 100A may be a portion of the keycap frame 100 that facilitates reception of the plurality of keycaps 102, such as through holes in the keycap frame 100, to allow the keycaps 102 to connect to sensors on a printed circuit board (PCB) through the openings in the keycap frame 100. The rectangular portion 100A has a first and a third side substantially parallel to each other and a second side and a third side substantially parallel to each other. For the rectangular potion 100A, substantially parallel means completely parallel or shifted by up to 10 degrees. The edges and corners of the rectangular portion 100A need not be straight—or flat. For example, the rectangular portion 100A may have rounded corners. As another example, the rectangular portion 100A may have tapered edges.

The plurality of keycaps 102 may be coupled to the keycap frame 100. Other keycap components or keyboard components may be positioned between or coupled to each keycap of the plurality of keycaps 102 and the keycap frame 100. For example, some of the keycap of the plurality of keycaps 102 may have casings (e.g., lower casing and upper casing), membrane layers (e.g., bottom, center, and top membranes), and domes (e.g., rubber domes) between the keycap and the keycap frame 100. The plurality of keycaps 102 need not be coupled to the keycap frame 100. The plurality of keycaps 102 may extend through a plurality of openings in the keycap frame 100. For example, the plurality of keycaps 102 may be coupled to a Printed Circuit Board (PCB) coupled to the keycap frame 100 or to another keyboard component and the plurality of keycaps 102 may extend through openings in the keycap frame 100. The plurality of keycaps 102 may be partially or completely extended relative to the openings in the keycap frame 100.

The keycap frame 100 may have any shape. For example, the keycap frame 100 may have a rectangular shape. The keycap frame 100 may have edges and corners. The edges and corners of the keycap frame 100 need not be straight—or flat. For example, the keycap frame 100 may have rounded corners. As another example, the keycap frame 100 may have tapered edges. The keycap frame 100 may be made with any material. For example, the keycap frame 100 may be made with biodegradable material, recyclable material, or bioplastic material. The keycap frame 100 may be treated to, among other things, increase the strength or durability of the keycap frame 100, including (for example) temperature resistance. For example, the keycap frame 100 may be sprayed with a graphene black matrix.

The first tab 104 may be coupled to one edge of the rectangular portion 100A of the keycap frame 100. For example, the first tab 104 may be coupled to one edge of the rectangular portion 100A of the keycap frame 100 using an adhesive, a fastener, or the like. The first tab 104 may also be an extended region of the frame 100 from the rectangular portion 100A. The first tab 104 and the rectangular portion 100A of the keycap frame 100 may be part of another structure. For example, the first tab 104 may be molded together with the rectangular portion 100A of the keycap frame 100 as a unitary piece.

The first tab 104 may have any shape. For example, the first tab 104 may have a cube shape or a cylindrical shape. The first tab 104 may have edges and corners. The edges and corners of the first tab 104 need not be straight—or flat. For example, the first tab 104 may have rounded corners. As another example, the first tab 104 may have tapered edges. The first tab 104 may be made with any material. For example, the first tab 104 may be made with biodegradable material, recyclable material, or bioplastic material. The first tab 104 may be treated to, among other things, increase the strength or durability of the first tab 104, including, for example, temperature resistance.

The first tab 104 may include a first retractable locking pin 106 coupled to a first end of the first tab 104 and configured to retract in a first direction. The first retractable locking pin 106 may be coupled to the first end of the first tab 104 in any way. For example, the first retractable locking pin 106 may be partially embedded within the first tab 104. The first retractable locking pin 106 may retract in any direction. For example, the first retractable locking pin 106 may retract in a direction parallel to the edge of the rectangular portion 100A of the keycap frame 100 that the first tab 104 is coupled to. As another example, the first retractable locking pin 106 may retract in a direction perpendicular to the edge of the rectangular portion 100A of the keycap frame 100 that the first tab 104 is coupled to.

The first tab 104 may include a second retractable locking pin 108 coupled to a second end of the first tab 104 and configured to retract in a second direction. The second retractable locking pin 108 may be coupled to the second end of the first tab 104 in any way. For example, the second retractable locking pin 108 may be partially embedded within the first tab 104. The second retractable locking pin 108 may retract in a direction that is opposite to the direction in which the first retractable locking pin 106 retracts. For example, in FIG. 1, when the first retractable locking pin 106 retracts towards the first tab 104 in a direction that is parallel to the edge of the rectangular portion 100A of the keycap frame 100 that the first tab 104 is coupled to, the second retractable locking pin 108 also retracts towards the first tab 104 but in an opposite direction that is parallel to the edge of the rectangular portion 100A of the keycap frame 100 that the first tab 104 is coupled to. As another example, when the first retractable locking pin 106 retracts in a first direction, the second retractable locking pin 108 retracts in a second, opposite direction, respectively. The second retractable locking pin 108 may retract at the same time as the first retractable locking pin 106, but does not need to.

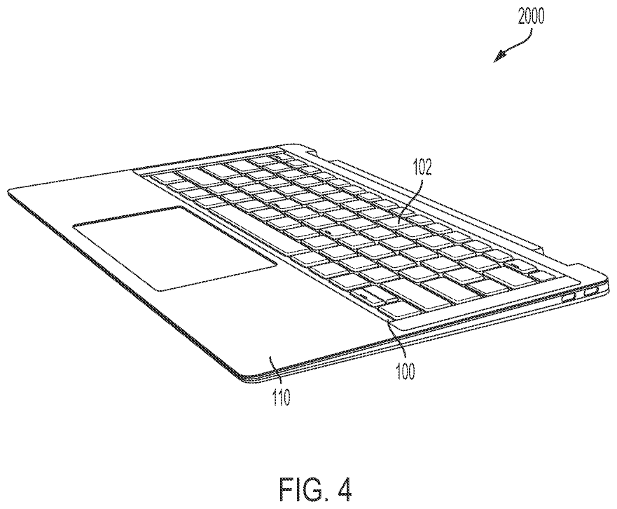

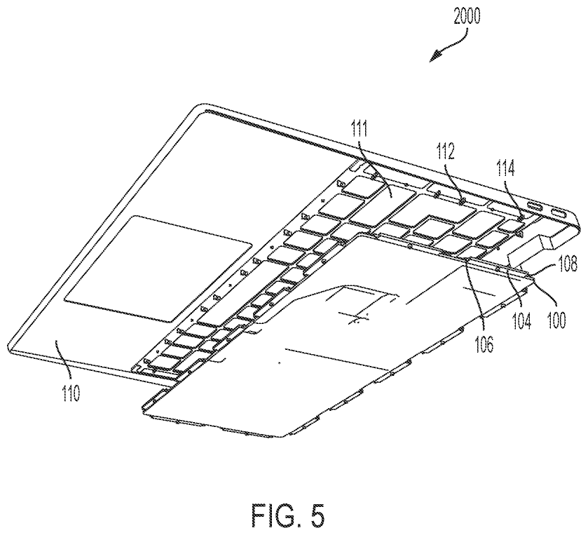

Referring to FIGS. 4 and 5, a schematic of an apparatus according to an example of the present disclosure is shown. The apparatus includes a keycap frame 100, keycaps 102, a first retractable locking pin 106, a second retractable locking pin 108, and a first cover 110.

The first cover 110 may have any shape and be designed to match a desired shape of an information handling system. For example, the first cover 110 may have a rectangular shape. The first cover 110 may have edges and corners. The edges and corners of the first cover 110 need not be straight—or flat. For example, the first cover 110 may have rounded corners. As another example, the first cover 110 may have tapered edges. The first cover 110 may be made with any material. For example, the first cover 110 may be made with biodegradable material, recyclable material, or bioplastic material. The first cover 110 may be treated to, among other things, increase the strength or durability of the first cover 110, including (for example) temperature resistance.

The first cover 110 may include one or more of an opening 111. The plurality of keycaps 102 may protrude through the one or more opening 111. The first cover may include a first recessed pocket 112 and a second recessed pocket 114.

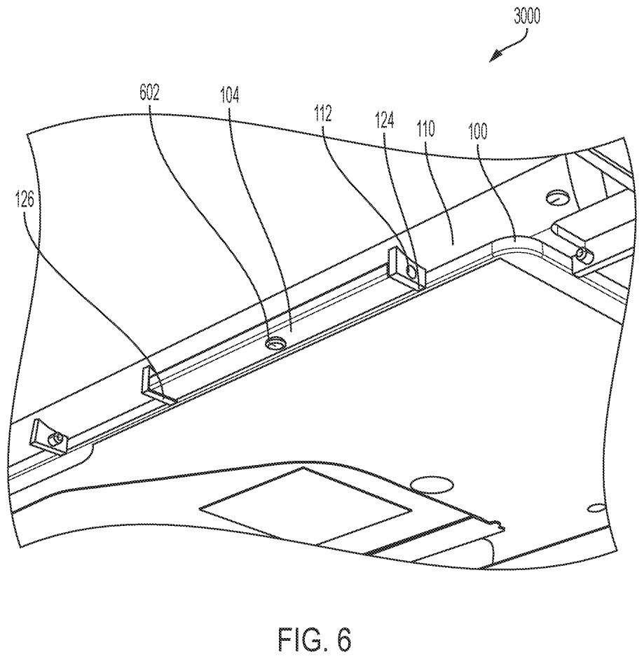

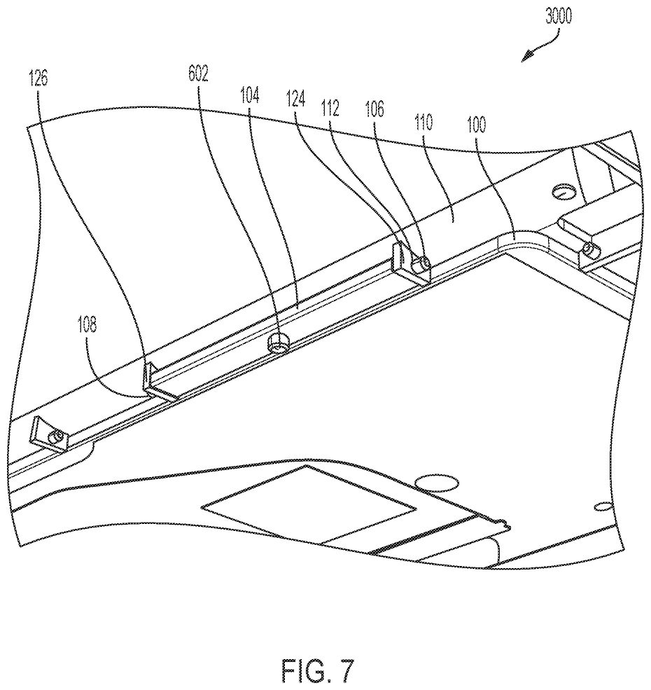

Referring to FIG. 6 and FIG. 7, a schematic of an apparatus according to an example of the present disclosure is shown. FIG. 6 shows a portion of the apparatus with the locking pins retracted; and FIG. 7 shows the same portion of the apparatus with the locking pins extended to secure the keycap frame to the cover. The apparatus includes a keycap frame 100, a first tab 104, a first retractable locking pin 106, a second retractable locking pin 108, and a first cover 110.

The first cover 110 may include a first recessed pocket 112. The first recessed pocket 112 is configured to receive the first retractable locking pin 106. The first recessed pocket 112 may be completely open (e.g., a hole) or partially open. The first recessed pocket 112 may have any width and depth. The first recessed pocket 112 may receive all or part of the first retractable locking pin 106. The first recessed pocket 112 may have any shape. For example, the first recessed pocket 112 may have a circular shape. The first recessed pocket 112 may be part of a tab 124 coupled to the first cover 110. For example, the tab 124 and the first cover 110 may be molded as a unitary piece.

The first cover 110 may include a second recessed pocket 114 (not visible in the shown perspective). The second recessed pocket 114 is configured to receive the second retractable locking pin 108. The second recessed pocket 114 may be completely open (e.g., a hole) or partially open. The second recessed pocket 114 may have any width and depth. The second recessed pocket 114 may receive all or part of the second retractable locking pin 108. The second recessed pocket 114 may have any shape. For example, the second recessed pocket 114 may have a circular shape. The second recessed pocket 114 may be part of a tab 126 coupled to the first cover 110. For example, the tab 126 and the first cover 110 may be molded as a unitary piece.

Referring to FIG. 7, a schematic of an apparatus according to an example of the present disclosure is shown. The apparatus includes a keycap frame 100, a first tab 104, a first retractable locking pin 106, a second retractable locking pin 108, a first recessed pocket 112 and a second recessed pocket 114. The first recessed pocket 112 may receive the first retractable locking pin 106. The second recessed pocket 114 (not visible in the shown perspective) may receive the second retractable locking pin 108. As shown in FIG. 7, when the first recessed pocket 112 has received the first retractable locking pin 106 and the second recessed pocket 114 has received the second retractable locking pin 108, the movement of the keycap frame 100 relative to the first cover 110 is at least partially restricted. The locking of the locking pins into the recessed pockets may significantly restrict movement of the cover relative to the frame such that the two components move as one fixed, rigid body, although some sizing and/or alignment errors may cause some relative movement.

In some embodiments, a button 602 may be included in the tab 104, in which the button 602 is depressed to retract the locking pins 106 and 108 together. When the button 602 is released, the locking pins 106 and 108 are released to extend into the first and second recessed pockets of the first cover 110.

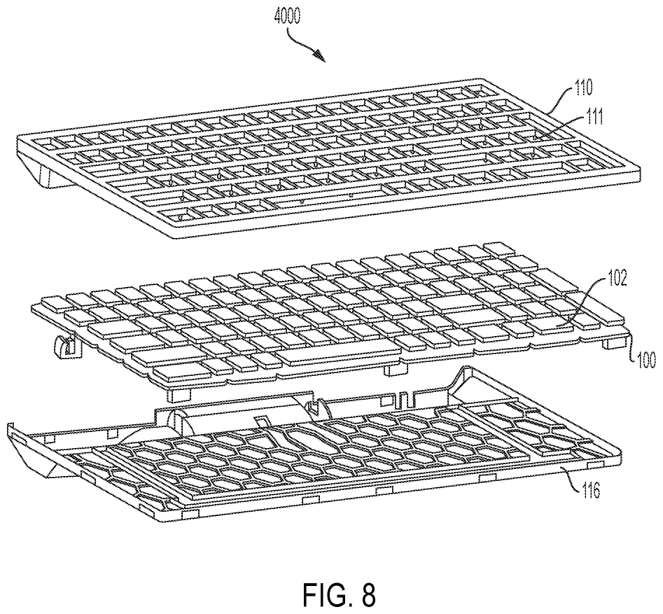

Referring to FIG. 8, a schematic of an apparatus according to an example of the present disclosure is shown. The apparatus includes a first cover 110, a keycap frame 100, and a second cover 116.

The second cover 116 may have any shape and be designed to match a desired shape of an information handling system. For example, the second cover 116 may have a rectangular shape. The second cover 116 may have edges and corners. The edges and corners of the second cover 116 need not be straight—or flat. For example, the second cover 116 may have rounded corners. As another example, the second cover 116 may have tapered edges. The second cover 116 may be made with any material. For example, the second cover 116 may be made with biodegradable material, recyclable material, or bioplastic material. The second cover 116 may be treated to, among other things, increase the strength or durability of the second cover 116, including, for example, temperature resistance to allow the placement of second cover 116 near a battery or other components that dissipate heat.

A portion of the keycap frame 100 may be positioned between a portion of the first cover 110 and a portion of the second cover 116. The plurality of keycaps 102 may protrude through the one or more of an opening 111. The first cover 110 may be coupled to the second cover 116. For example, a portion of a perimeter of the first cover 110 may be coupled with an ultrasound bioepoxy weld to a portion of a perimeter of the second cover 116. In some embodiments, the first cover 110 and the second cover 116 may create a volume that can at least partially enclose the keycap frame 100. In some embodiments, the volume may at least partially enclose other keyboard components. In some embodiments, all four corners of the first cover 110 may be coupled with an ultrasound bioepoxy to the four corners of the second cover 116. In some embodiments, the keycap frame 100 is coupled to the first cover 110 without using screws. In some embodiments, the keycap frame 100 is coupled to the first cover 110 without using screws and the second cover 116 is coupled to the first cover 110 without using screws.

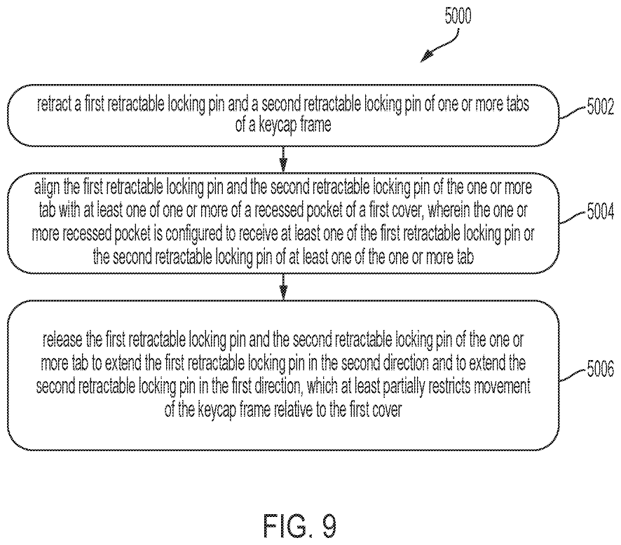

Referring now to FIG. 9, shown is a method of assembling an apparatus according to an example of the present disclosure. A method 5000 of assembling an apparatus, such as the apparatus 1000, the apparatus 2000, or the apparatus 3000, is shown. The method 5000 includes, at block 5002, retracting a first retractable locking pin (e.g., 106) and a second retractable locking pin (e.g., 108) of one or more tabs (e.g., 104) of a keycap frame (e.g., 100). The method 5000 further includes, at block 5004, aligning the first retractable locking pin and the second retractable locking pin of the one or more tab with at least one of one or more of a recessed pocket (e.g., 112, 114) of a first cover (e.g., 110), in which the one or more recessed pocket is configured to receive at least one of the first retractable locking pin or the second retractable locking pin of at least one of the one or more tab. The method 5000 further includes, at block 5006, releasing the first retractable locking pin and the second retractable locking pin of the one or more tab to extend the first retractable locking pin in the second direction and to extend the second retractable locking pin in the first direction, in which the extension of the first retractable locking pin and the second retractable locking pin of the one or more tab causes the first retractable locking pin and the second retractable locking pin to be received by at least one of the one or more recessed pocket of the first cover to at least partially restrict movement of the keycap frame relative to the first cover.

In some embodiments, the method 5000 may include a step of positioning a portion of the keycap frame between a portion of the first cover and a portion of a second cover, in which the one or more keycap (e.g., 102) are configured to protrude through one or more openings of the first cover. In some embodiments, the method 5000 may include a step of coupling a portion of a perimeter of the first cover and a portion of a perimeter of the second cover using an ultrasound bioepoxy weld. In some embodiments, the method 5000 may include a step of coupling a keyboard assembly comprising the keycap frame, the first cover, and the second cover to a processor configured to receive input from the keyboard assembly. In some embodiments, the method 5000 may include a step of coupling a display to the processor.

According to some embodiments, a method of assembly of a keyboard assembly may include locking the keycap frame to another component with the locking pins. Next, some portion of a perimeter of the keycap frame and the other component may be ultrasound bioepoxy welded, such as at four corners of the rectangular portion 100A. Next, a back assembly biodegradable polymer light guide may be attached to the keycap cover. A graphene black matrix may be sprayed on the biopolymer of the other component to facilitate temperature control.

The top cover (sometimes referred to as the first cover herein) can include renewable and or recycled content. In some aspects, the top cover can include from 10 wt. % to 80 wt. % renewable content. In some aspects the top cover can optionally include up to 70 wt. % recycled content. The top cover can include a polyester and a plurality of jute fibers. In some aspects, the top cover can be a first laminate that includes a first layer and a second layer. In some aspects, the first laminate first layer comprises a polyester. In some aspects, the first laminate first layer can include virgin polyester material and post-consumer resin (PCR). In some aspects, the first laminate first layer can include from 30 wt. % to 100 wt. % virgin polyester material. The first laminate first layer can include 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt. % of virgin polyester material. In some aspects, the top cover first laminate first layer can optionally include up to 70 wt. % PCR. The top cover first laminate first layer can include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt. % PCR, or any value therein. In some aspects, the first laminate first layer can include from 30 wt. % to 99 wt. % virgin polyester material and from 1 wt. % to 70 wt. % PCR. In some aspects, the top cover has a thickness ranging from 1.8 mm to 5 mm. In some aspects, the top cover thickness can be 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 mm, or any value therein. In some aspects, the first laminate first layer has a thickness ranging from 0.8 mm to 2.0 mm. The first laminate first layer can have a thickness of 0.8, 0.9, 1.0, 1.1, 1.2, 1.3, 1.4, 1.5, 1.6, 1.7, 1.8, 1.9, 2.0 mm, or any value therein. In some aspects, the first laminate second layer has a thickness ranging from 1.0 to 3.0 mm. The first laminate second layer can have a thickness of 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0 mm, or any value therein. In some aspects, the polyester is a second polylactic acid (PLA, i.e., the PLA in the top cover may be different from or the same as the PLA in the bottom cover). In some aspects, the first laminate first layer can be made from a manufacturing process selected from the group consisting of plastic injection, rotational (roto) molding, extrusion blow molding, injection blow molding, reaction injection molding (RIM), vacuum casting, thermoforming and compression molding.

In some aspects, the first laminate second layer comprises a plurality of jute fibers. In some aspects, the plurality of jute fibers of the first laminate second layer can be provided in the form of a fabric layer. In some aspects, the plurality of jute fibers comprises cellulose, hemicellulose, pectin, lignin, or a combination thereof. In specific aspects, the plurality of jute fibers comprise from 60 wt. % to 70 wt. % cellulose, from 14 wt. % to 20 wt. % hemicellulose, about 0.2 wt. % pectin, about 12 wt. % lignin, a moisture content of 11 wt. %, and about 0.5 wt. % wax.

In some aspects, the top cover (sometimes referred to as the first cover herein) has a tensile modulus greater than 4,000 Mpa, measured in accordance with ASTM D638. In some aspects, the top cover has a tensile strength greater than 80 Mpa, measured in accordance with ASTM D638. In some aspects, the top cover has a flexural modulus greater than 5,000 Mpa, measured in accordance with ASTM D790A. In some aspects, the top cover has a flexural strength greater than 110 Mpa, measured in accordance with ASTM D790A. In some aspects, the top cover has a compressive strength greater than 17400 psi, measured in accordance with ASTM D695.

In some aspects, the bottom cover (sometimes referred to as the second cover herein) comprises a molded composition comprising a first PLA (i.e., the PLA in the bottom cover may be different from or the same as the PLA in the top cover) and post-consumer resin (PCR). In some aspects, the PLA and PCR are molded together. In some aspects, the PLA and PCR constitute a third layer, and the bottom cover further comprises a fourth layer comprising a plurality of jute fibers. In some aspects, the layer of jute fibers is attached to the PLA/PCR layer by the use of an adhesive. The adhesive connecting the third PLA/PCR layer and the fourth jute fiber layer can be a second recyclable or biodegradable adhesive. In some aspects, the bottom cover comprises from 10 wt. % to 60 wt. % of the first PLA, from 10 wt. % to 20 wt. % of the PCR, and a balance of jute fibers. In some aspects, the PCR comprises polyethylene terephthalate (PET), polybutylene terephthalate (PBT), high-impact polystyrene (HIPS), acrylonitrile butadiene styrene (ABS), polycarbonate (PC), or any combination of the foregoing. In some aspects, the first PLA has a density ranging from 1.1 to 1.4 g/cm3. In some aspects, the first PLA has a melt flow index ranging from 20 to 25 g/10 min, measured in accordance with ISO 1133-A at 210° C. In some aspects, the first PLA has a melt flow index ranging from 8 to 12 g/10 min, measured in accordance with ISO 1133-A at 190° C. In some aspects, the first PLA has a stereochemical purity of greater than 99%. In some aspects, the first PLA has a water content of less than or equal to 400 ppm. In some aspects, the first PLA has a melting temperature ranging from 165° C. to 185° C. In some aspects, the first PLA has a glass transition temperature ranging from 55° C. to 65° C.

Some aspects of the disclosure are directed to a keyboard for an information handling system comprising a top cover comprising a polyester and a plurality of jute fibers, a keycap assembly comprising one or more keycaps, a bottom cover comprising a metallic composition comprising at least one of magnesium (Mg), aluminum (Al), and steel. In some aspects, the metallic composition comprises from 80 wt. % to 90 wt. % of magnesium, from 5 wt. % to 10 wt. % of aluminum, and from 5 wt. % to 10 wt. % of steel. In some aspects, at least a portion of the magnesium in the bottom cover comprises recycled magnesium. The amount of recycled magnesium in the bottom cover may constitute 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt. % of the total magnesium in the bottom cover. In some aspects, at least a portion of the aluminum in the bottom cover comprises recycled aluminum. The amount of recycled aluminum in the bottom cover may constitute 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt. % of the total aluminum in the bottom cover. In some aspects, at least a portion of the steel in the bottom cover comprises recycled steel. The amount of recycled steel in the bottom cover may constitute 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt. % of the total steel in the bottom cover. In some aspects, the bottom cover is formed by a die cast method. In some aspects, the bottom cover has a thickness ranging from 1.5 mm to 2.5 mm. In some aspects, the bottom cover has a tensile modulus greater than 30,000 Mpa, measured in accordance with ASTM D638. In some aspects, the bottom cover has a tensile strength greater than 160 Mpa, measured in accordance with ASTM D638. In some aspects, the bottom cover has a flexural modulus greater than 10,000 Mpa, measured in accordance with ASTM D790A. In some aspects, the bottom cover has a flexural strength greater than 50 Mpa, measured in accordance with ASTM D790A. In some aspects, the bottom cover further comprises a battery compartment. In some embodiments, the bottom cover has recycled metal content of at least 80% and up to 100% of the magnesium when the bottom cover comprises magnesium, of between 5-10% of the aluminum or more when the bottom cover comprises aluminum, or of between 5-10% of the steel or more when the bottom cover comprises steel. Additional details regarding materials for components of a keyboard assembly may be found in co-pending U.S. patent application Ser. No. 17/471,430, which his incorporated by reference herein.

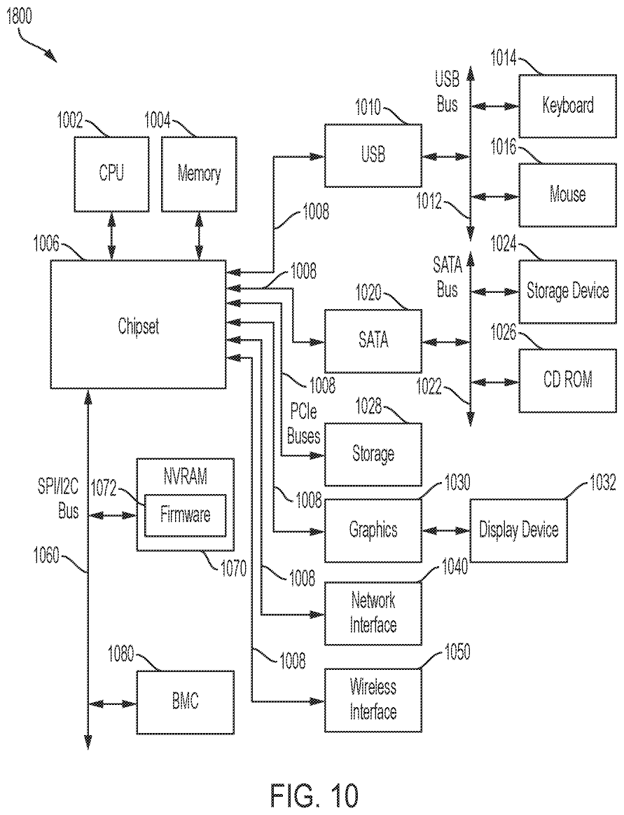

One information handling system incorporating a keyboard assembly according to one of the embodiments described herein is shown in FIG. 10. The keyboard assembly may include electronic components as keyboard 1014 coupled to USB interface 1410.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

FIG. 10 illustrates an example information handling system 1800. Information handling system 1800 may include a processor 1002 (e.g., a central processing unit (CPU)), a memory (e.g., a dynamic random-access memory (DRAM)) 1004, and a chipset 1006. In some embodiments, one or more of the processor 1002, the memory 1004, and the chipset 1006 may be included on a motherboard (also referred to as a mainboard), which is a printed circuit board (PCB) with embedded conductors organized as transmission lines between the processor 1002, the memory 1004, the chipset 1006, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 1002, the memory 1004, the chipset 1006, and/or other components may be organized as a System on Chip (SoC).

The processor 1002 may execute program code by accessing instructions loaded into memory 1004 from a storage device, executing the instructions to operate on data also loaded into memory 1004 from a storage device, and generate output data that is stored back into memory 1004 or sent to another component. The processor 1002 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 1002 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 1006 may facilitate the transfer of data between the processor 1002, the memory 1004, and other components. In some embodiments, chipset 1006 may include two or more integrated circuits (ICs), such as a northbridge controller coupled to the processor 1002, the memory 1004, and a southbridge controller, with the southbridge controller coupled to the other components such as USB 1010, SATA 1020, and PCIe buses 1008. The chipset 1006 may couple to other components through one or more PCIe buses 1008.

Some components may be coupled to one bus line of the PCIe buses 1008, whereas some components may be coupled to more than one bus line of the PCIe buses 1008. One example component is a universal serial bus (USB) controller 1010, which interfaces the chipset 1006 to a USB bus 1012. A USB bus 1012 may couple input/output components such as a keyboard 1014 and a mouse 1016, but also other components such as USB flash drives, or another information handling system. Another example component is a SATA bus controller 1020, which couples the chipset 1006 to a SATA bus 1022. The SATA bus 1022 may facilitate efficient transfer of data between the chipset 1006 and components coupled to the chipset 1006 and a storage device 1024 (e.g., a hard disk drive (HDD) or solid-state disk drive (SDD)) and/or a compact disc read-only memory (CD-ROM) 1026. The PCIe bus 1008 may also couple the chipset 1006 directly to a storage device 1028 (e.g., a solid-state disk drive (SDD)). A further example of an example component is a graphics device 1030 (e.g., a graphics processing unit (GPU)) for generating output to a display device 1032, a network interface controller (NIC) 1040, and/or a wireless interface 1050 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 1006 may also be coupled to a serial peripheral interface (SPI) and/or Inter-Integrated Circuit (I2C) bus 1060, which couples the chipset 1006 to system management components. For example, a non-volatile random-access memory (NVRAM) 1070 for storing firmware 1072 may be coupled to the bus 1060. As another example, a controller, such as a baseboard management controller (BMC) 1080, may be coupled to the chipset 1006 through the bus 1060. BMC 1080 may be referred to as a service processor or embedded controller (EC). Capabilities and functions provided by BMC 1080 may vary considerably based on the type of information handling system. For example, the term baseboard management system may be used to describe an embedded processor included at a server, while an embedded controller may be found in a consumer-level device. As disclosed herein, BMC 1080 represents a processing device different from processor 1002, which provides various management functions for information handling system 1000. For example, an embedded controller may be responsible for power management, cooling management, and the like. An embedded controller included at a data storage system may be referred to as a storage enclosure processor or a chassis processor.

System 1800 may include additional processors that are configured to provide localized or specific control functions, such as a battery management controller. Bus 1060 can include one or more busses, including a Serial Peripheral Interface (SPI) bus, an Inter-Integrated Circuit (I2C) bus, a system management bus (SMBUS), a power management bus (PMBUS), or the like. BMC 1080 may be configured to provide out-of-band access to devices at information handling system 1000. Out-of-band access in the context of the bus 1060 may refer to operations performed prior to execution of firmware 1072 by processor 1002 to initialize operation of system 1800.

Firmware 1072 may include instructions executable by processor 1002 to initialize and test the hardware components of system 1800. For example, the instructions may cause the processor 1002 to execute a power-on self-test (POST). The instructions may further cause the processor 1002 to load a boot loader or an operating system (OS) from a mass storage device. Firmware 1072 additionally may provide an abstraction layer for the hardware, such as a consistent way for application programs and operating systems to interact with the keyboard, display, and other input/output devices. When power is first applied to information handling system 1000, the system may begin a sequence of initialization procedures, such as a boot procedure or a secure boot procedure. During the initialization sequence, also referred to as a boot sequence, components of system 1800 may be configured and enabled for operation and device drivers may be installed. Device drivers may provide an interface through which other components of the system 1800 can communicate with a corresponding device. The firmware 1072 may include a basic input-output system (BIOS) and/or include a unified extensible firmware interface (UEFI). Firmware 1072 may also include one or more firmware modules of the information handling system. Additionally, configuration settings for the firmware 1072 and firmware of the information handling system 1000 may be stored in the NVRAM 1070. NVRAM 1070 may, for example, be a non-volatile firmware memory of the information handling system 1000. NVRAM 1070 may further store one or more container-specific firmware memory map namespaces for one or more containers concurrently executed by the information handling system.

Information handling system 1000 may include additional components and additional busses, not shown for clarity. For example, system 1800 may include multiple processor cores (either within processor 1002 or separately coupled to the chipset 1006 or through the PCIe buses 1008), audio devices (such as may be coupled to the chipset 1006 through one of the PCIe busses 1008), or the like. While a particular arrangement of bus technologies and interconnections is illustrated for the purpose of example, one of skill will appreciate that the techniques disclosed herein are applicable to other system architectures. System 1800 may include multiple processors and/or redundant bus controllers. In some embodiments, one or more components may be integrated together in an integrated circuit (IC), which is circuitry built on a common substrate. For example, portions of chipset 1006 can be integrated within processor 1002. Additional components of information handling system 1000 may include one or more storage devices that may store machine-executable code, one or more communications ports for communicating with external devices, and various input and output (I/O) devices, such as a keyboard, a mouse, and a video display.

In some embodiments, processor 1002 may include multiple processors, such as multiple processing cores for parallel processing by the information handling system 1000. For example, the information handling system 1000 may include a server comprising multiple processors for parallel processing. In some embodiments, the information handling system 1000 may support virtual machine (VM) operation, with multiple virtualized instances of one or more operating systems executed in parallel by the information handling system 1000. For example, resources, such as processors or processing cores of the information handling system may be assigned to multiple containerized instances of one or more operating systems of the information handling system 1000 executed in parallel. A container may, for example, be a virtual machine executed by the information handling system 1000 for execution of an instance of an operating system by the information handling system 1000. Thus, for example, multiple users may remotely connect to the information handling system 1000, such as in a cloud computing configuration, to utilize resources of the information handling system 1000, such as memory, processors, and other hardware, firmware, and software capabilities of the information handling system 1000. Parallel execution of multiple containers by the information handling system 1000 may allow the information handling system 1000 to execute tasks for multiple users in parallel secure virtual environments.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. An apparatus, comprising:
a keycap frame comprising a rectangular portion having a plurality of keycaps;
a first tab coupled to one edge of the rectangular portion;
a first retractable locking pin coupled to a first end of the first tab and configured to retract in a first direction; and
a second retractable locking pin coupled to a second end of the first tab and configured to retract in a second direction that is opposite to the first direction.

2. The apparatus of claim 1, further comprising:
a first cover comprising:
a first recessed pocket configured to receive the first retractable locking pin; and
a second recessed pocket configured to receive the second retractable locking pin;
wherein movement of the keycap frame relative to the first cover is at least partially restricted when the first recessed pocket has received the first retractable locking pin and the second recessed pocket has received the second retractable locking pin.

3. The apparatus of claim 2, wherein the keycap frame is coupled to the first cover without using screws.

4. The apparatus of claim 2, further comprising: a second cover, wherein:
the first cover comprises one or more of an opening;
a portion of the keycap frame is positioned between a portion of the first cover and a portion of the second cover; and
the plurality of keycaps are configured to protrude through the one or more opening of the first cover.

5. The apparatus of claim 4, wherein at least a portion of a perimeter of the first cover is coupled with an ultrasound bioepoxy weld to at least a portion of a perimeter of the second cover.

6. The apparatus of claim 4, wherein the first cover, the keycap frame, and the second cover comprise at least one of biodegradable material, recyclable material, or bioplastic material.

7. The apparatus of claim 6, wherein:
the first cover comprises a polyester and a plurality of jute fibers, and
the second cover comprises a first polylactic acid (PLA) and a post-consumer resin (PCR).

8. The apparatus of claim 7, wherein the keycap frame comprises sprayed graphene black matrix.

9. The apparatus of claim 1, wherein:
the first tab, the first retractable locking pin, and the second retractable locking pin are part of a fastener;
the apparatus further comprising:
one or more of the fastener; and
a first cover comprising one or more of a recessed pocket configured to receive at least one of the first retractable locking pin or the second retractable locking pin of at least one of the one or more fastener.

10. The apparatus of claim 9, wherein the keycap frame is coupled to the first cover without using screws.

11. An apparatus, comprising:
a keyboard assembly comprising:
a keycap frame comprising a rectangular portion having a plurality of keycaps;
a first tab coupled to one edge of the rectangular portion;
a first retractable locking pin coupled to a first end of the first tab and configured to retract in a first direction;
a second retractable locking pin coupled to a second end of the first tab and configured to retract in a second direction that is opposite to the first direction;
a first cover comprising:
one or more of an opening;
a first recessed pocket configured to receive the first retractable locking pin to at least partially restrict movement of the keycap frame relative to the first cover; and
a second recessed pocket configured to receive the second retractable locking pin to at least partially restrict movement of the keycap frame relative to the first cover; and
a second cover configured to couple to the first cover to create a volume that can at least partially enclose the keycap frame;
wherein:
a portion of the keycap frame is positioned between a portion of the first cover and a portion of the second cover, and
the plurality of keycaps are configured to protrude through the one or more opening of the first cover.

12. The apparatus of claim 11, wherein the apparatus is an information handling system, the information handling system further comprising:
a processor coupled to the keyboard assembly and configured to receive input from the keyboard assembly; and
a display coupled to the processor.

13. The apparatus of claim 11, wherein the keycap frame is coupled to the first cover without using screws.

14. The apparatus of claim 11, wherein at least a portion of a perimeter of the first cover is coupled with an ultrasound bioepoxy weld to at least a portion of a perimeter of the second cover.

15. The apparatus of claim 14, wherein the first cover, the keycap frame, and the second cover comprise at least one of biodegradable material, recyclable material, or bioplastic material.

16. The apparatus of claim 15, wherein the keycap frame comprises sprayed graphene black matrix.

17. The apparatus of claim 15, wherein the first cover comprises a polyester and a plurality of jute fibers and the second cover comprises a first polylactic acid (PLA) and a post-consumer resin (PCR).

18. A method, comprising:
retracting a first retractable locking pin and a second retractable locking pin of one or more tabs of a keycap frame;
aligning the first retractable locking pin and the second retractable locking pin of the one or more tab with at least one of one or more of a recessed pocket of a first cover, wherein the one or more recessed pocket is configured to receive at least one of the first retractable locking pin or the second retractable locking pin of at least one of the one or more tab; and
releasing the first retractable locking pin and the second retractable locking pin of the one or more tab to extend the first retractable locking pin in the second direction and to extend the second retractable locking pin in the first direction, wherein an extension of the first retractable locking pin and the second retractable locking pin of the one or more tab causes the first retractable locking pin and the second retractable locking pin to be received by at least one of the one or more recessed pocket of the first cover to at least partially restrict movement of the keycap frame relative to the first cover.

19. The method of claim 18, further comprising:
positioning a portion of the keycap frame between a portion of the first cover and a portion of a second cover, wherein the one or more keycap are configured to protrude through one or more openings of the first cover; and
coupling a portion of a perimeter of the first cover and a portion of a perimeter of the second cover using an ultrasound bioepoxy weld.

20. The method of claim 19, further comprising:
coupling a keyboard assembly comprising the keycap frame, the first cover, and the second cover to a processor configured to receive input from the keyboard assembly; and
coupling a display to the processor.
